(19) United States
(12) Patent Application Publication
(10) Pub. No.: US 2011/0179580 A1
(43) Pub. Date: Jul. 28, 2011

(54) Interconnectable Grid Section for a Mattress Core

(76) Inventor: Rainer Wieland, Venice, CA (US)

(21) Appl. No.: 13/080,432

(22) Filed: Apr. 5, 2011

Related U.S. Application Data
(63) Continuation-in-part of application No. 12/101,825, filed on Apr. 11, 2008.
(60) Provisional application No. 61/322,251, filed on Apr. 8, 2010.

(51) Int. Cl. A47C 23/04; A47C 17/00; B23P 11/00

(52) U.S. Cl. 5/719; 5/690; 29/428; 29/91.1

(57) ABSTRACT

The invention is a grid section for a mattress core, wherein springs are mounted back to back on the grid section and wherein the grid section is attached to other grid sections in a two dimensional array to create an interconnected grid array. The grid section is cross shaped with four arms. Each arm has either a male or female tip. The male and female tips of the grid sections fit together to form the mattress grid array.

### CROSS REFERENCE TO RELATED APPLICATIONS

This application is a Continuation-in-Part of U.S. Non-Provisional patent application Ser. No. 12/101,825, filed on Apr. 11, 2008, titled “Grid Spring Mattress,” by inventor Rainer Wieland, the contents of which are expressly incorporated herein by this reference, and to which priority is claimed. Priority is also claimed to U.S. Provisional Patent Application No. 61/322,251, filed on Apr. 8, 2010, titled “Grid Section for a Mattress,” by inventor Rainer Wieland, the contents of which are expressly incorporated herein by this reference, as though set forth herein in full.

### FIELD OF INVENTION

This invention generally relates to a grid section that, when interconnected with other grid sections, form a base or array to which springs are connected to form a mattress spring core. More specifically, the invention relates to a cross-shaped interconnectable grid piece that is able to matingly connect with two springs and four other grid pieces to form a double-sided spring core for a mattress.

### BACKGROUND

For centuries, people have been sleeping on mattresses to get a more comfortable rest, in order to be elevated above the floor, and to gain protection from the elements. Several challenges face designers of mattresses including, for example, how to provide a reasonably priced high quality mattress, how to provide sufficient ergonomic support, how to reduce the amount of the sleeper's perspiration that is absorbed and retained by the mattress, and how to make the springs of the mattress last longer and provide more comfort.

The two most common types of mattresses are the metal spring mattress and the foam mattress. Although both the metal spring mattress and the foam mattress provide a more comfortable rest than sleeping on the floor, neither type of mattress adequately reduces the absorption and retention of moisture and perspiration by the mattress. Moisture and perspiration absorption and retention by the mattress is undesirable because dust mites thrive on the retained moisture. Excessive dust mites lead to excessive dust mite dander and waste, which can cause an allergic response in many people. Foam mattresses that do not have springs are especially susceptible to retaining moisture, dander, or other allergens.

Metal spring mattresses, in addition to retaining excessive moisture in the padded section, are undesirable for several other reasons. First, the metal springs of these mattresses fatigue from prolonged use, start to sag, and become increasingly less comfortable. Inexpensive metal spring mattresses do not sufficiently protect the sleeper from pressure points caused by the metal springs. Further, metal spring mattresses are also very heavy, which makes them very difficult to move or flip over. Finally, metal spring mattresses have electro-magnetic fields, which can interfere with sleep.

Regarding references that disclose spring arrays, U.S. Pat. No. 6,427,990, issued to Hartmann, discloses an array of spring baskets that are attached to heavy square supporting plates. The Hartmann supporting plates are connected to each other with the use of straight connecting arms. The connecting arms extend from a middle of a first supporting plate and attach to connecting lug on an outer area of a second supporting plate. Unfortunately, the connecting arms, connecting lugs, and heavy supporting plates provide a difficult to assemble and irregular spring array that requires the use of mounting pins. Additionally, the Hartmann heavy plates are connected on the top and the bottom of the basket spring and the plates are then connected with arms with each other. This is the same way that metal springs have been connected for years, and this causes unwanted motion transfer. What is needed is a center array that is sandwiched between two springs and reduces or eliminates motion transfer.

Therefore, there is a need in the art for a mattress that is light, substantially free of metal, ergonomic, comfortable, and allows proper ventilation to reduce the amount of perspiration and moisture that is absorbed and retained by the mattress. There is also a need for a lightweight spring array for such a mattress, which has a plurality of easy to interconnect grid sections.

### SUMMARY OF THE INVENTION

To minimize the limitations in the prior art, and to minimize other limitations that will become apparent upon reading and understanding the present specification, the present invention discloses a grid section for a mattress core, wherein two springs are mounted back to back on a the grid section, and wherein the grid section is attached to other grid sections in a two dimensional array to form an interconnected grid array.

One embodiment of the present invention is a grid section for a mattress core, comprising: a first grid section. The first grid section is comprised of a base and a plurality of arms, which radiate distally away from the base. Each of the arms has a distal end. The distal ends of the plurality of arms of the first grid section are adapted to matingly join with a distal end of an arm of a second grid section. Preferably the first grid section is includes one or more spring connectors. The spring connectors are preferably adapted to matingly engage with a mattress spring. The arms of the grid section are preferably substantially on a horizontal plane. The spring connectors typically extend away from the base on a vertical plane. The distal end of the arms may have either a female tip or a male tip. The female tip and the male tip are adapted to matingly engage with each other. Preferably, there are four arms that are at ninety (90) degree angles to each other to form a cross, with the base at the center. Preferably, there are two spring connectors, one on top of the base, and the other on the opposite and bottom side of the base. Two of the four arms should have male tips and two of the four arms have female tips. Preferably, each male tip has a pawl that interconnects with a notch in the female tip when the two tips are matingly engaged.

Another embodiment of the invention is a sectional grid array for a mattress core, comprising: five grid sections, a middle grid section, a forward grid section, a back grid section, a right grid section, and a left grid section. Each of the five grid sections is comprised of a base, four arms, and two spring connectors. The four arms radiate distally away from the base on a substantially horizontal plane. The four arms are at a ninety degree angle from each other such that a cross shape is formed. The two spring connectors extend away from the base on opposite sides of each other on a vertical plane. The two spring connectors matingly engage with a mattress spring, such that the grid section is sandwiched between two springs, which are preferably Bellville springs. Each of the four arms has a distal end such each grid section has four distal ends. The four distal ends consist of a front male tip, a right male tip, a back female tip, and a left female tip. The five grid sections are attached to each other as follows: the front male tip of the middle grid section matingly engages with the back female tip of the forward grid section; the right female tip of the middle grid section matingly engages with the left male tip of the right grid section; the back female tip of the middle grid section matingly engages with the front male tip of the back grid section; and the left male tip of the middle grid section matingly engages with the right female tip of the left grid section. Preferably the male tips have a pawl and wherein the female tips each have a notch. The pawl and the notch are adapted to matingly engage with each other.

Another embodiment of the invention is a method of constructing a grid array for a mattress core comprising the steps of: providing five interconnectable grid sections; wherein the five grid sections consist of a middle grid section, a forward grid section, a back grid section, a right grid section, and a left grid section; wherein each of the five grid sections is comprised of a base, four arms, and two spring connectors; wherein the four arms radiate distally away from the base on a substantially horizontal plane; wherein the four arms are at a ninety degree angle from each other such that a cross shape is formed; wherein each of the four arms has a distal end such each grid section has four distal ends; wherein the four distal ends consist of a front male tip, a right female tip, a back female tip, and a left male tip; connecting the front male tip of the middle grid section with the back female tip of the forward grid section; connecting the right female tip of the middle grid section with the left male tip of the right grid section; connecting the back female tip of the middle grid section with the front male tip of the back grid section; and connecting wherein the left male tip of the middle grid section with the right female tip of the left grid section. Preferably, the two spring connectors consist of a top side spring connector and a bottom side spring connector. The top side spring connector extends above a top side of the base; and the bottom side spring connector extends below a bottom side of the base. The method may also include the steps of connecting a top side mattress spring to the top side spring connector; connecting a bottom side mattress spring to the bottom side spring connector; wherein the male tips have a pawl and wherein the female tips each have a notch; wherein the pawl and the notch are adapted to matingly engage with each other.

An object of the present invention is to provide a grid section of a mattress core grid array that snaps together easily with other grid sections and that allows Bellville springs to be easily connected to both sides of the grid section. Although the grid array may be taken apart if so desired, the pieces are designed to stay connected to provide a comfortable, lightweight and sturdy mattress core. Preferably the grid sections are made of plastic, but they may be made out of any material without deviating from the scope of the invention.

Another object of the present invention is to provide a mattress that is not made with wire or metal springs that can cause: 1) painful pressure points and prevents muscles from fully relaxing; 2) electromagnetic fields; and 3) the mattress to be excessively heavy.

The invention is a grid section that, when combined with other grid sections, forms a lattice-work that supports a double sided array of springs. Two Belleville springs are attached at the grid section bases on opposing sides. The grid supports are connected to each other grid supports such that the mounted springs are held at a set distance from each other to form a spring array. The spring support plates are directed away from and parallel to the spring base. With appropriate distribution of interconnected spring mounted grid supports, the support plates of the springs act as a de facto support plane when they contact the cover layer, typically foam or other type of padding, to which they are adjacent. The spring support plates, unlike traditional metal springs, need no additional bracing beyond what is provided by the other spring components and the single flexible interconnect grid section array. When the grid section and grid section array of the present invention is inserted into the mattress cavity, the core formed is relatively hollow, and thus allows for beneficial ventilation.

Other features and advantages are inherent in the mattress claimed and disclosed will become apparent to those skilled in the art from the following detailed description and its accompanying drawings.

### BRIEF DESCRIPTION OF THE DRAWINGS

FIG. 1 is an illustration of a perspective view of one embodiment of the grid section and shows the female tip.

FIG. 2 is an illustration of a perspective view of one embodiment of the grid section and shows the male tip.

FIG. 3 is an illustration of a top view of one embodiment of a grid section.

FIG. 4 is an illustration of a cross-section view of one embodiment of a grid section.

FIG. 5 is an illustration of a top view of one embodiment of a grid section connected to four other grid sections to form a grid array.

### DETAILED DESCRIPTIONS OF THE DRAWINGS

In the following detailed description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance “plastic” refers to any natural or synthetic polymer resin including, but not limited to, cellulose, polyethylene, or polystyrene. Preferably, the grid section of the present invention is made of plastic, but may be made of any natural or manmade material without deviating from the scope of the invention. The grid section is preferably made from a single piece of formed plastic, but may be constructed from any number of pieces that are attached, permanently or temporarily to each other.

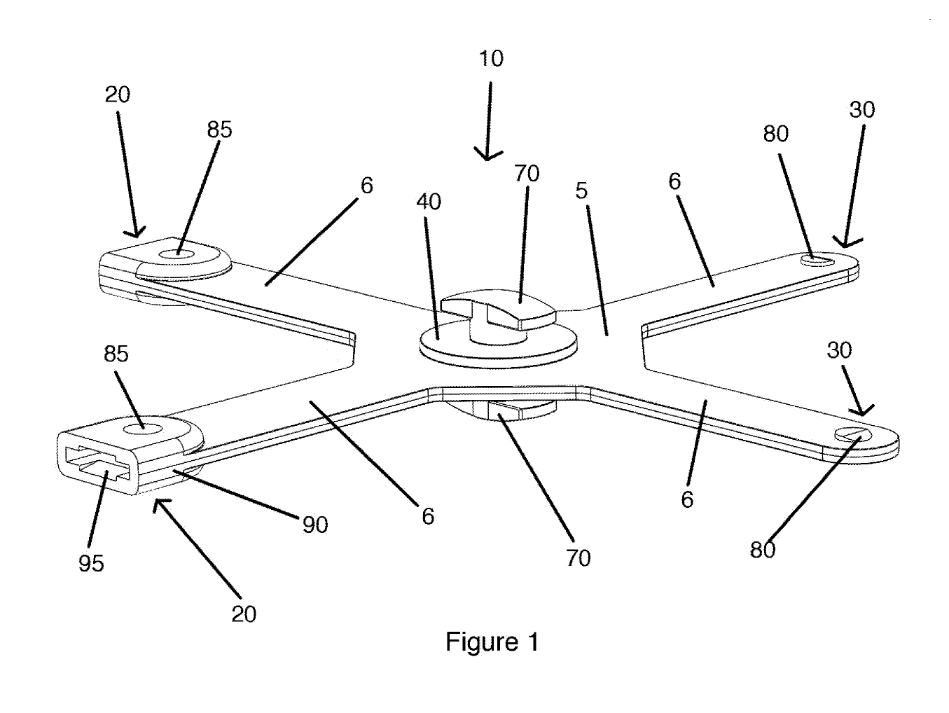

FIG. 1 is an illustration of a perspective view of one embodiment of the grid section and shows the female tip. As shown in FIG. 1, the grid section 10 is substantially flat and preferably is comprised of base 5, arms 6, female tips 20, male tips 30, spring connector bases 40, spring connector 70, pawl 80, notch 85, female housing 90, and female cavity 95.

FIG. 1 shows that male tips 30 have raised portion or pawl 80 that matingly engages with the notch 50 of female tips 20 when two grid sections are engaged and substantially interlocked. The notch 50 houses the pawl 80, after the sloped pawl has been forced into notch 50, and prevents the male tip 30 from being easily removed from female tip 20. In alternate embodiments, a plurality of pawls and notches may be present one each tip without deviating from the scope of the invention.

FIG. 1 shows how the base 5 preferably has four arms radiating outward from the base in a substantially horizontal plane. Although FIG. 1 shows that there are four arms 6, any number of arms may be used, so long as the arms may be connected to the arms on other grid sections to form a grid array. The center base 40 contains a plurality of arms and spring connectors. Each arm 6 preferably has either a female tip 20 or male tip 30. The center base 5 also preferably has two spring connectors 70, one on the top and one on the bottom of the grid section 10. As shown in FIG. 1, the spring connectors 70 are substantially in a vertical plane. The spring connectors remain stationary in relation to the grid section as one or more Bellville springs are engaged to the grid.

Preferably, the female tip 20 is comprised of female housing 90 and female cavity 95. The female housing 90 protrudes vertically from the female tip 20 and forms female cavity 95. The notches 85 are preferably substantially cylindrical in shape, but any shape may be used. The notches 85 are also typically on the top and bottom portions of the female housing 90. As shown in FIG. 1, the female cavity 95 is adapted to have the male tip inserted into the cavity in order to couple two arms 6 from different grid sections.

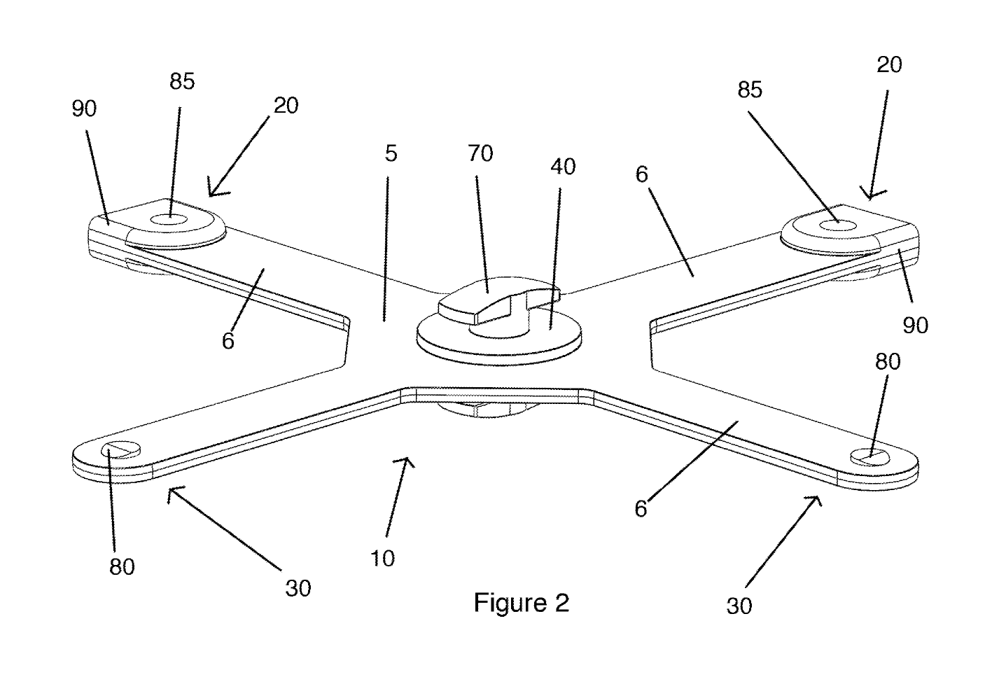

FIG. 2 is an illustration of a perspective view of one embodiment of the grid section and shows the male tip. FIG. 2 shows that the pawl 80 is cylindrical, and adapted to fit with notch 85. FIG. 2 also shows that pawl 80 is sloped or slanted to allow it to slide into female cavity 95 and engage with notch 85. When the pawl 80 is engaged with the notch 85, pawl 80 is preferably kept securely in place due to friction, unless and/or until it is released by a user.

FIGS. 1 and 2 show that two of the arms 6 have female tips 20 and two have male tips 30. Depending upon the design and structure of the other grid sections, grid section 10 may have any combination of male tips 30 to female tips 20, or may have only one type of tip, without deviating from the scope of the invention.

As shown in FIG. 2, the spring connectors 70 are preferably at the center of the base 5 of grid section 10. In this manner, the mattress springs that are connected to grid section 10, enjoy even support from grid section 10 and will allow the spring to spread annularly or horizontally towards other springs without coming into contact with the other springs. Because Bellville springs may expand more with heavier loads, it is desirable to allow enough space between the springs to allow the Bellville springs to fully expand while also providing enough support for the user while they use a fully-assembled grid mattress.

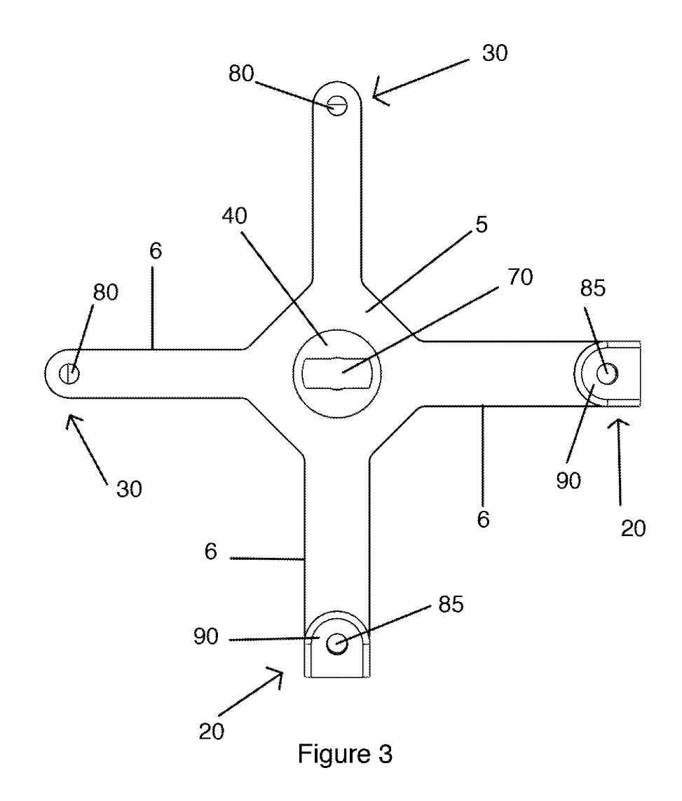

FIG. 3 is an illustration of a top view of one embodiment of a grid section. As shown in FIG. 3, the grid section 10 is substantially flat and preferably is comprised of base 5, arms 6, female tips 20, male tips 30, spring connector base 40, spring connector 70, pawl 80, notch 85, and female housing 90. FIG. 3 shows how the grid section 10 is preferably cross-shaped and has four arms 6 that radiate outward from the base 5 on a substantially horizontal plane. The grid section 10 may have fewer or more arms. For example the corner grid section may have only two arms.

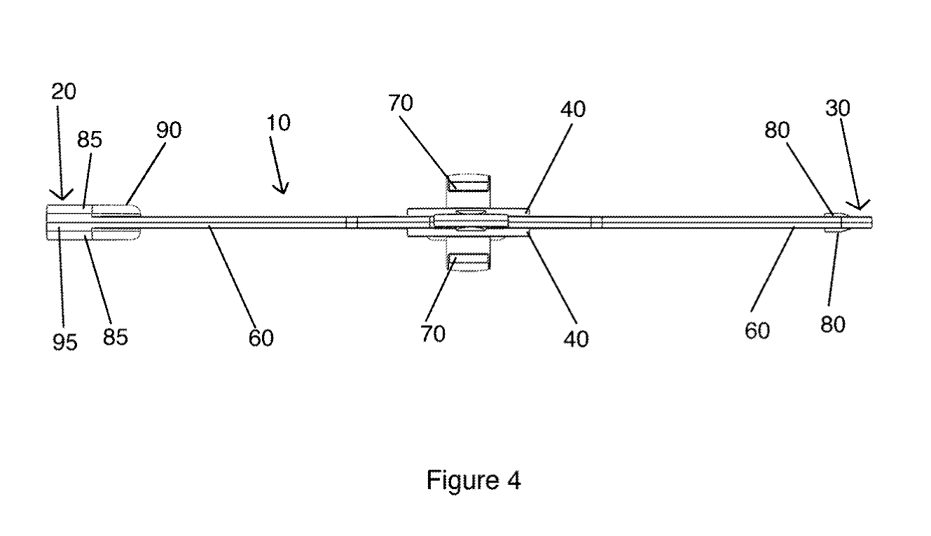

FIG. 4 is an illustration of a cross-section view of one embodiment of a grid section. As shown in FIG. 4, the grid section 10 is substantially flat and preferably is comprised of base 5, arms 6, female tip 20, male tip 30, spring connector bases 40, spring connectors 70, pawl 80, notches 85, female housing 90, and female cavity 95. Although FIG. 4 only shows one pawl 80 on a top side of male tip 30, it should be understood that there may be any number of pawls, and they may be on any side of said male tip. Additionally, it should be understood that the male tips 30 may have notches and the female tips 20 may have pawls, so long as the male tips 30 and female tips 20 engage with each other to form a sturdy connection.

FIG. 4 also shows how, preferably, pawl 80, female housing 90, spring connector bases 40, and spring connectors 70 all extend vertically from the base 5 or arms 6. FIG. 4 shows how the female cavity 95 is preferably adapted to allow male tip 30 to enter and engage with female tip 20. The spring connectors 70 are preferably a plastic male latch that fits into the base of a spring. Once the spring is fitted over the spring connector 70, the spring is then turned or twisted approximately ninety degrees to lock the spring onto the spring connector 70. The spring connector 70 effectively prevents the mattress spring from coming loose from the grid section. When the user wants to remove the spring, the spring is twisted so that the spring connector 70 no longer prevents the spring from being removed. The type of spring used in conjunction with the present invention is a Bellville spring. Although two spring connectors 70 are shown in FIG. 4, it should be understood that there may be only one spring connector, for a one-sided mattress core, or any number of spring connectors, depending on the size of the springs and the size of the grid section 10.

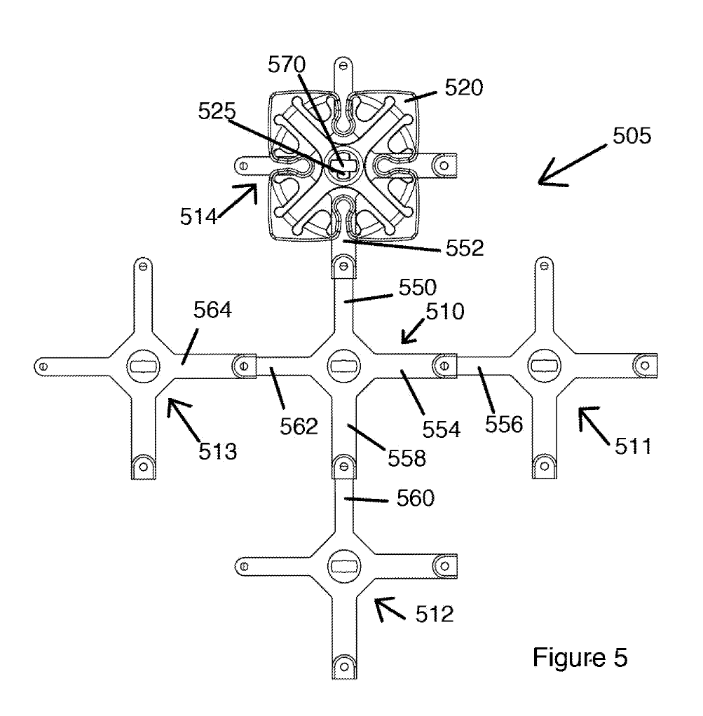

FIG. 5 is an illustration of a top view of one embodiment of a grid section connected to four other grid sections to form a grid array. As shown in FIG. 5, the grid array 505 is preferably comprised of a plurality of grid sections, including middle grid section 510, right grid section 511, back grid section 512, left grid section 513, and forward grid section 514. FIG. 5 shows how the grid array 505 is made up of interconnected grid sections. Specifically, FIG. 5 shows the preferred connections of: the front male tip 550 of the middle grid section 510 matingly engaged with the back female tip 552 of the forward grid section 514; the right female tip 554 of the middle grid section 510 matingly engaged with the left male tip 556 of the right grid section 511; the back female tip 558 of the middle grid section 510 matingly engaged with the front male tip 560 of the back grid section 512; and the left male tip 562 of the middle grid section 510 matingly engaged with the right female tip 564 of the left grid section 513. The terms “left,” “right,” “forward,” and “back” are used for orientation purposes only to show how each grid section may preferably connect to one to four other grid sections to form a grid array. Preferably, enough grid sections are matingly engaged or connected to each other to form a grid array for a core of a mattress. As such, dozens or even hundreds of the grid sections may have to be interconnected in order to form the correct size grid array.

FIG. 5 shows a preferred embodiment of the grid sections 510, 511, 512, 513, and 514, with two adjoining male tips that are at ninety degrees to each other, and two adjoining female tips that are at ninety degrees to each other and opposite the male tips. Should the grid sections be rotated or flipped, the apparent positions of the male and female tips would naturally change. The grid sections, in another embodiment, may have the female tips directly across from each other and at ninety degree angles to the male tips, which would also be directly across from each other.

FIG. 5 also shows spring 520, which is preferably a Bellville spring, connected to grid section 514. The spring 520 preferably has slot 525 that fits over spring connector 570. The spring 520 is then twisted ninety degrees to lock the spring 520 in place on the grid section 514. Preferably, the springs are attached to both sides of each grid section in the spring array to form a double sided mattress core.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A grid section for a mattress core, comprising:
a first grid section;
wherein said first grid section is comprised of a base and a plurality of arms;
wherein said plurality of arms radiate distally away from said base;
wherein said plurality of arms have a distal end;
wherein said distal end of said plurality of arms of said first grid section are adapted to matingly join with a distal end of an arm of a second grid section.

2. The grid section for a mattress core of claim 1, wherein said first grid section is further comprised of:
one or more spring connectors;
wherein said one or more spring connectors are adapted to matingly engage with a mattress spring.

3. The grid section for a mattress core of claim 2, wherein said plurality of arms that radiate distally away from said base are on substantially on a horizontal plane.

4. The grid section for a mattress core of claim 3, wherein said one or more spring connectors extend away from said base on a vertical plane.

5. The grid section for a mattress core of claim 4, wherein said distal end of said plurality of arms has a tip selected from the group consisting of a female tip and a male tip;
wherein said female tip and said male tip are adapted to matingly engage with each other.

6. The grid section for a mattress core of claim 5, wherein there are four of said plurality of arms;
wherein said four arms extend away from said base at a ninety degree angle from each other such that a cross shape is formed.

7. The grid section for a mattress core of claim 6, wherein there are two of said one or more spring connectors;
wherein said two spring connectors extend away from said base on opposite sides of each other.

8. The grid section for a mattress core of claim 6, wherein two of said four arms have male tips and wherein two of said four arms have female tips.

9. The grid section for a mattress core of claim 8, wherein said male tip has a pawl and wherein said female tip has a notch;
wherein said pawl is adapted to matingly engage with said notch.

10. A sectional grid array for a mattress core, comprising:
five grid sections;
wherein said five grid sections consists of a middle grid section, a forward grid section, a back grid section, a right grid section, and a left grid section;
wherein each of said five grid sections is comprised of a base, four arms, and two spring connectors;
wherein said four arms radiate distally away from said base on a substantially horizontal plane;
wherein said four arms are at a ninety degree angle from each other such that a cross shape is formed;
wherein said two spring connectors extend away from said base on opposite sides of each other on a vertical plane;
wherein each of said two spring connectors matingly engage with a mattress spring;
wherein each of said four arms has a distal end such each grid section has four distal ends;
wherein said four distal ends consist of a front male tip, a right male tip, a back female tip, and a left female tip;
wherein said front male tip of said middle grid section matingly engages with said back female tip of said forward grid section; wherein said right female tip of said middle grid section matingly engages with said left male tip of said right grid section; wherein said back female tip of said middle grid section matingly engages with said front male tip of said back grid section; and wherein said left male tip of said middle grid section matingly engages with said right female tip of said left grid section.

11. The grid section for a mattress core of claim 8, wherein said male tips have a pawl and wherein said female tips each have a notch; wherein said pawl and said notch are adapted to matingly engage with each other.

12. A method of constructing a grid array for a mattress core comprising the steps of:
providing five interconnectable grid sections;
wherein said five grid sections consist of a middle grid section, a forward grid section, a back grid section, a right grid section, and a left grid section;
wherein each of said five grid sections is comprised of a base, four arms, and two spring connectors;
wherein said four arms radiate distally away from said base on a substantially horizontal plane;
wherein said four arms are at a ninety degree angle from each other such that a cross shape is formed;
wherein each of said four arms has a distal end such each grid section has four distal ends;
wherein said four distal ends consist of a front male tip, a right male tip, a back female tip, and a left female tip;
connecting said front male tip of said middle grid section with said back female tip of said forward grid section;
connecting said right female tip of said middle grid section with said left male tip of said right grid section;
connecting said back female tip of said middle grid section with said front male tip of said back grid section;
connecting wherein said left male tip of said middle grid section with said right female tip of said left grid section;

13. A method of constructing a grid array for a mattress core of claim 12, wherein said two spring connectors consist of a top side spring connector and a bottom side spring connector;
wherein said top side spring connector extends above a top side of said base; and
wherein said bottom side spring connector extends below a bottom side of said base;
connecting a top side mattress spring to said top side spring connector;
connecting a bottom side mattress spring to said bottom side spring connector.

14. The method of constructing a grid array for a mattress core of claim 13, wherein said male tips have a pawl and wherein said female tips each have a notch;
wherein said pawl and said notch are adapted to matingly engage with each other.
